(19) United States
(12) Patent Application Publication
(10) Pub. No.: US 2015/0336474 A1
(43) Pub. Date: Nov. 26, 2015

(54) VEHICLE POWER SUPPLY APPARATUS AND VEHICLE POWER REGENERATION SYSTEM

(71) Applicant: Masakazu Okaniwa, Aichi (JP)

(72) Inventor: Masakazu Okaniwa, Aichi (JP)

(73) Assignee: OMRON AUTOMOTIVE ELECTRONICS CO., LTD., Aichi (JP)

(21) Appl. No.: 14/715,929

(22) Filed: May 19, 2015

(30) Foreign Application Priority Data
May 21, 2014 (JP) 2014-105417

(51) Int. Cl. B60L 15/20; B60L 7/16; B60L 15/00

(52) U.S. Cl. CPC B60L 15/2045; B60L 15/007; B60L 7/16; Y10S 903/903

(57) ABSTRACT

A vehicle power supply apparatus includes: a switching element; a DC-DC converter; and a control unit. When a vehicle is travelling, and a generator does not generate electricity, if a voltage of an electricity storage unit is greater than a predetermined value, the control unit turns on the switching element, and controls driving of the DC-DC converter such that the electricity storage unit discharges electricity to supply electric power of the electricity storage unit to loads, and even if the voltage of the electricity storage unit decreases to the predetermined value, as long as the vehicle speed is greater than or equal to a threshold value, the control unit turns on the switching element, and controls the driving of the DC-DC converter such that the electricity storage unit discharges electricity to supply the electric power of the electricity storage unit to the loads.

### CROSS-REFERENCES TO RELATED APPLICATIONS

This application is based upon and claims the benefit of priority from Japanese Patent Application No. 2014-105417, filed on May 21, 2014; the entire contents of which are incorporated herein by reference.

### FIELD

One or more embodiments of the present invention relate to a vehicle power supply apparatus and a vehicle power regeneration system which are configured to charge an electricity storage unit with regenerative electric power generated by a generator, and to supply electric power to a load from the electricity storage unit or a direct-current power supply.

### BACKGROUND

A vehicle, which has an idling stop function (a start-stop function) and a deceleration regenerative function so as to protect the environment of the earth and improve fuel consumption, has been developed. This type of vehicle is provided with a power regeneration system or a power supply apparatus configured to charge an electricity storage unit with regenerative electric power that is generated by a generator during speed reduction, or to supply electric power from the electricity storage unit or a battery (direct-current power supply) to a load. The electricity storage unit is configured as a capacitor or the like, and the battery is configured as a lead-acid battery in the related art.

For example, the power supply apparatus disclosed in Japanese Unexamined Patent Application Publication No. 2011-155791 or illustrated in FIG. 7 in Japanese Patent No. 4835690 includes a switch that is provided on an electric power path between a battery and a load (narrow voltage range accessory) which is required to be protected in such a manner that a voltage supplied to the load does not decrease. A diode is connected in parallel to the switch. The electricity storage unit is connected to an electric power path between the switch and the load via a DC-DC converter. The generator, a starter motor, or other loads (accessories, wide range voltage accessories) are connected to an electric power path between the battery and the switch.

When a speed reduction of the vehicle causes the generator to generate regenerative electric power, the switch is turned on, and the DC-DC converter causes the electricity storage unit to be charged with the regenerative electric power. When the generator does not perform normal electric power generation that consumes fuel, or when the generator does not generate regenerative electric power, the switch is turned on, and the DC-DC converter causes the electricity storage unit to discharge electricity. In the technology disclosed in Japanese Unexamined Patent Application Publication No. 2011-155791, the electricity storage unit discharges electricity until the voltage of the electricity storage unit reaches a predetermined voltage at which the DC-DC converter can operate and the electricity storage unit can continuously drive the load over a predetermined period of time during which the voltage of the battery decreases instantaneously. When the voltage of the electricity storage unit decreases to the predetermined voltage, the discharging of the electricity storage unit is stopped, the engine is re-started, the generator generates normal electric power, and the normal electric power is supplied to the load.

Since the starter motor is started up to re-start the engine when the idling stop in which an engine of the vehicle is stopped by a start-stop system ends, a high current flows to the starter motor and the voltage of the battery decreases instantaneously. Therefore, in that case, the switch is turned off, and the load and the electricity storage unit are electrically disconnected from the battery and the starter motor, the electric power of the electricity storage unit is supplied to the load via the DC-DC converter. Accordingly, the load is continuously and stably driven with electric power from the electricity storage unit.

### SUMMARY

In the related art, when the voltage of the electricity storage unit being discharged decreases to the predetermined voltage while the generator is not in an electric power generation mode, the discharging of the electricity storage unit is stopped, and an improvement in fuel consumption is inhibited when the engine is re-started in order to generate electricity with the generator.

If the electric power of the electricity storage unit is used up when the engine is re-started after the ending of the idling stop, the electric power cannot be supplied from the electricity storage unit to the load that is a target for protection.

An object of one or more embodiments of the present invention is to improve fuel consumption of a vehicle by using regenerative electric power, and to reliably supply electric power to a load when the engine is re-started.

According to one or more embodiments of the invention, there is provided a vehicle power supply apparatus including: a switching element including one end connectable to a direct-current power supply to which a first load and a generator are connected in parallel, and the other end connectable to a second load which is required to be protected such that a voltage supplied to the second load does not decrease; a bi-directional DC-DC converter including a first input/output terminal connected to the other end of the switching element and the second load, and a second input/output terminal connected to an electricity storage unit which stores regenerative electric power generated by the generator; a control unit which controls an operation of the switching element and the DC-DC converter; a voltage detection unit which detects a voltage of the electricity storage unit; and a communication unit which receives a status of a vehicle and a vehicle speed from an upper-level apparatus.

According to one or more embodiments of the invention, there is provided a vehicle power regeneration system including: a direct-current power supply; a first load and a generator which are connected in parallel to the direct-current power supply; a second load which is required to be protected such that a voltage supplied to the second load does not decrease; an electricity storage unit which stores regenerative electric power generated by the generator; and a vehicle power supply apparatus which supplies electric power from the direct-current power supply and the electricity storage unit to the first load and the second load.

In this configuration, when the vehicle is travelling, and the generator does not generate electricity, if the voltage of the electricity storage unit is greater than a predetermined value, the control unit of the vehicle power supply apparatus turns on the switching element, and controls driving of the DC-DC converter such that the electricity storage unit discharges electricity to supply the electric power of the electricity storage unit to the first load and the second load, and even if the voltage of the electricity storage unit decreases to the predetermined value, as long as the vehicle speed is greater than or equal to a threshold value, the control unit turns on the switching element, and controls the driving of the DC-DC converter such that the electricity storage unit discharges electricity to supply the electric power of the electricity storage unit to the first load and the second load.

As described above, when the vehicle is travelling, and the generator is not in an electric power generation mode, if the voltage of the electricity storage unit being discharged decreases to the predetermined value, and the vehicle speed is greater than or equal to the threshold value, the electricity storage unit continuously discharges electricity, and the electric power of the electricity storage unit is continuously supplied to the loads. For this reason, it is possible to improve the fuel consumption of the vehicle by using the electric power of the electricity storage unit charged with the regenerative electric power until the electric power is used up. Since the vehicle speed is greater than or equal to the threshold value, the electricity storage unit can be reliably charged with the regenerative electric power generated by the generator when the speed of the vehicle is reduced thereafter. For this reason, when the engine is re-started again thereafter, the electricity storage unit discharges electricity, and electric power can be supplied from the electricity storage unit to the second load. At this time, electric power can be supplied from the direct-current power supply to the first load.

In the vehicle power supply apparatus according to one or more embodiments of the invention, when the vehicle is travelling, and the generator does not generate electricity, if the voltage of the electricity storage unit decreases to the predetermined value, and the vehicle speed is less than the threshold value, the control unit may turn on the switching element, and stop the driving of the DC-DC converter, such that the electricity storage unit does not discharge electricity.

In the vehicle power supply apparatus according to one or more embodiments of the invention, when an engine of the vehicle is re-started, the control unit may turn off the switching element, control the driving of the DC-DC converter such that the electricity storage unit discharges electricity to supply the electric power of the electricity storage unit to the second load.

In the vehicle power supply apparatus according to one or more embodiments of the invention, the predetermined value may be set to be higher than or equal to a value of the voltage of the electricity storage unit at which the electricity storage unit can supply electric power required to drive the second load when the engine of the vehicle is re-started.

In the vehicle power supply apparatus according to one or more embodiments of the invention, when the generator generates regenerative electric power, the control unit may turn on the switching element to supply the regenerative electric power to the second load, and may control the driving of the DC-DC converter to charge the electricity storage unit with the regenerative electric power.

In the vehicle power supply apparatus according to one or more embodiments of the invention, the threshold value may be set to be higher than or equal to a value of a vehicle speed at which the electricity storage unit can be charged with electric power required to drive the second load when the engine is re-started by the regenerative electric power generated by the generator by reduction of a speed of the vehicle thereafter.

In the vehicle power supply apparatus according to one or more embodiments of the invention, the switching element may include a field effect transistor to which a rectifier is connected in parallel, and the rectifier may allow current to flow from the direct-current power supply to the second load.

In the vehicle power supply apparatus according to one or more embodiments of the invention, the first load may include a starter motor which is started up to start the engine, and through which a high current flows during start-up of the starter motor.

According to one or more embodiments of the invention, it is possible to improve the fuel consumption of a vehicle by using regenerative electric power, and to reliably supply electric power to each load when the engine is re-started.

### BRIEF DESCRIPTION OF THE DRAWINGS

FIG. 1 is a diagram illustrating a circuit configuration of a vehicle power supply apparatus and a vehicle power regeneration system according to an embodiment of the invention;

FIG. 2 is a diagram illustrating an operation of a circuit illustrated in FIG. 1 during normal electric power generation that consumes fuel;

FIG. 3 is a diagram illustrating an operation of the circuit illustrated in FIG. 1 during electric power regeneration;

FIG. 4 is a diagram illustrating an operation of the circuit illustrated in FIG. 1 when a vehicle is travelling and electric power is not generated;

FIG. 5 is a diagram illustrating an operation of the circuit illustrated in FIG. 1 when the voltage of a capacitor decreases to a lower limit value when the vehicle is travelling and electric power is not generated;

FIG. 6 is a diagram illustrating an operation of the circuit illustrated in FIG. 1 when the idling stop ends and the engine is re-started; and

FIG. 7 is a timing chart illustrating the operation of the circuit illustrated in FIG. 1 and a vehicle.

### DETAILED DESCRIPTION

In embodiments of the invention, numerous specific details are set forth in order to provide a thorough understanding of the invention. However, it will be apparent to one of ordinary skill in the art that the invention may be achieved without these specific details. In other instances, well-known features have not been described in detail to avoid obscuring the invention.

Hereinafter, an embodiment of the invention will be described with reference to the accompanying drawings. In the drawings, the same reference signs are assigned to identical parts or corresponding parts.

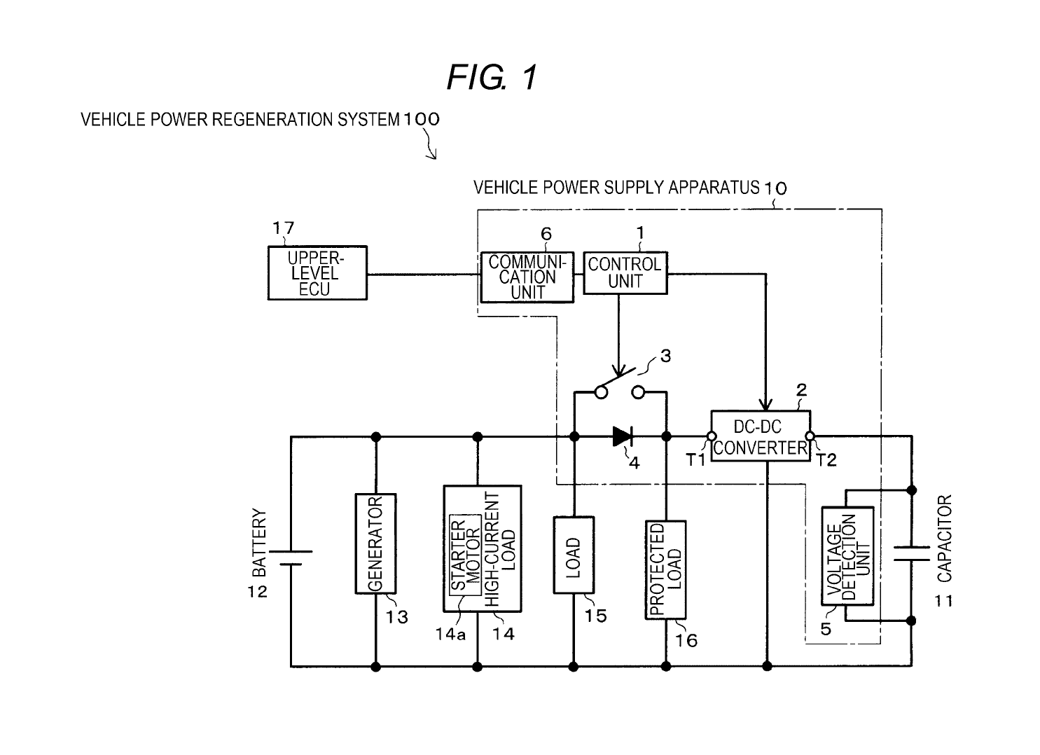

First, the circuit configuration of a vehicle power regeneration system 100 and a vehicle power supply apparatus 10 is described with reference to FIG. 1.

The vehicle power regeneration system 100 is mounted in a vehicle having an idling stop function (a start-stop function) and a deceleration regenerative function. The vehicle power regeneration system 100 includes the vehicle power supply apparatus 10; a capacitor 11; a battery 12; a generator 13; a high-current load 14; a load 15; a protected load 16; and an upper-level electronic control unit (ECU) 17.

The capacitor 11 is configured as an electric double-layer capacitor, and is an example of an “electricity storage unit” according to one or more embodiments of the invention. The electricity storage unit may be configured as a lithium-ion battery, a lithium-ion capacitor, a nickel-metal hydride battery, or the like in addition to being configured as an electric double-layer capacitor.

The battery 12 is configured as a lead-acid battery in the related art, and is an example of a “direct-current power supply” according to one or more embodiments of the invention. The direct-current power supply may be configured as a battery or an electric cell in addition to being configured as a “lead-acid” battery. The generator 13 and the loads 14 and 15 are connected in parallel to the battery 12.

The generator 13 is driven by the engine of the vehicle (both not illustrated), and generates electricity. For example, during acceleration, constant-speed travelling, or stopping of the vehicle, a driving force of the engine drives the generator 13 so that electricity is generated. For example, when the voltage of the battery 12 is sufficiently high, the generator 13 does not generate electricity.

Even if the speed of the vehicle is reduced or the vehicle brakes are operated, the vehicle travels continuously, and even though fuel is not supplied to the vehicle, the engine rotates. A rotating force of the engine is used to drive the generator 13 so that electricity is generated. The electric power generated by the generator 13 during the deceleration of the vehicle or the like is referred to as regenerative electric power. The capacitor 11 stores electric power generated by the generator 13. The supply of fuel to the engine is stopped when the speed of the vehicle is reduced. That is, since electricity is generated without the consumption of fuel, the fuel consumption of the vehicle improves.

The high-current load 14 is configured as an electric motor or the like through which a high current flows during the start-up of the electric motor. The high-current load 14 includes a starter motor 14a configured to start the engine. The high-current load 14 includes a power steering motor, an electric brake system (both not illustrated), and the like as other examples.

The load 15 is configured as electrical equipment that may not be used during an idling stop in which an engine of the vehicle is stopped by a start-stop system. The load 15 includes an electric seat heater and the like. The high-current load 14 and the load 15 are “first loads” according to one or more embodiments of the invention.

The protected load 16 is configured as electrical equipment to which it is necessary to supply electric power even during an idling stop of the vehicle, and is required to be protected in such a manner that a voltage supplied to the electrical equipment does not decrease when the idling stop ends and the engine is re-started (during the start-up of the starter motor 14a) or the like. The protected load 16 includes a navigation system, audio equipment, an air conditioner, an instrument panel, a transmission, a safety apparatus, and the like. The protected load 16 is a “second load” according to one or more embodiments of the invention.

The upper-level ECU 17 is connected to the vehicle power supply apparatus 10 via a controller area network (CAN) or the like. The upper-level ECU 17 communicates with the vehicle power supply apparatus 10. The upper-level ECU 17 transmits information indicative of a status or speed of the vehicle, an operation instruction, or the like to the vehicle power supply apparatus 10. The upper-level ECU 17 is an “upper-level apparatus” according to one or more embodiments of the invention.

The vehicle power supply apparatus 10 includes a control unit 1; a DC-DC converter 2; a switch 3; a diode 4; a voltage detection unit 5, and a communication unit 6.

The control unit 1 is made up of a CPU and a memory, and controls the operation of the DC-DC converter 2 and the switch 3. The DC-DC converter 2 includes two input/output terminals T1 and T2, and has a bi-directional voltage step-up/down function.

The switch 3 is configured as a field effect transistor (FET). One end of the switch 3 is connected to a positive pole of the battery 12, the generator 13, and the loads 14 and 15. The other end of the switch 3 is connected to the protected load 16 and the DC-DC converter 2. The switch 3 is an example of a “switching element” according to one or more embodiments of the invention.

The diode 4 connected in parallel to the switch 3 is a parasitic diode of the FET that forms the switch 3. An anode of the diode 4 is connected to the one end of the switch 3, the positive pole of the battery 12, the generator 13, and the loads 14 and 15. A cathode of the diode 4 is connected to the protected load 16 and the DC-DC converter 2. For this reason, the diode 4 allows current to flow from the battery 12 to the protected load 16. The diode 4 is an example of a “rectifier” according to one or more embodiments of the invention.

The first input/output terminal T1 of the DC-DC converter 2 is connected to the other end of the switch 3 and the protected load 16. The second input/output terminal T2 of the DC-DC converter 2 is connected to the capacitor 11.

The voltage detection unit 5 is configured to detect the voltage of the capacitor 11. The control unit 1 calculates a charge level of the capacitor 11 based on a detected value obtained by the voltage detection unit 5, and drives the DC-DC converter 2 so that the charging and discharging of the capacitor 11 is performed.

The communication unit 6 is configured as a circuit which communicates with the upper-level ECU 17 via the CAN. The control unit 1 receives an operation instruction along with information indicative of a state of the vehicle or vehicle speed information transmitted from the upper-level ECU 17 via the communication unit 6. The control unit 1 transmits a status (charge level or the like) of the capacitor 11 to the upper-level ECU 17 via the communication unit 6.

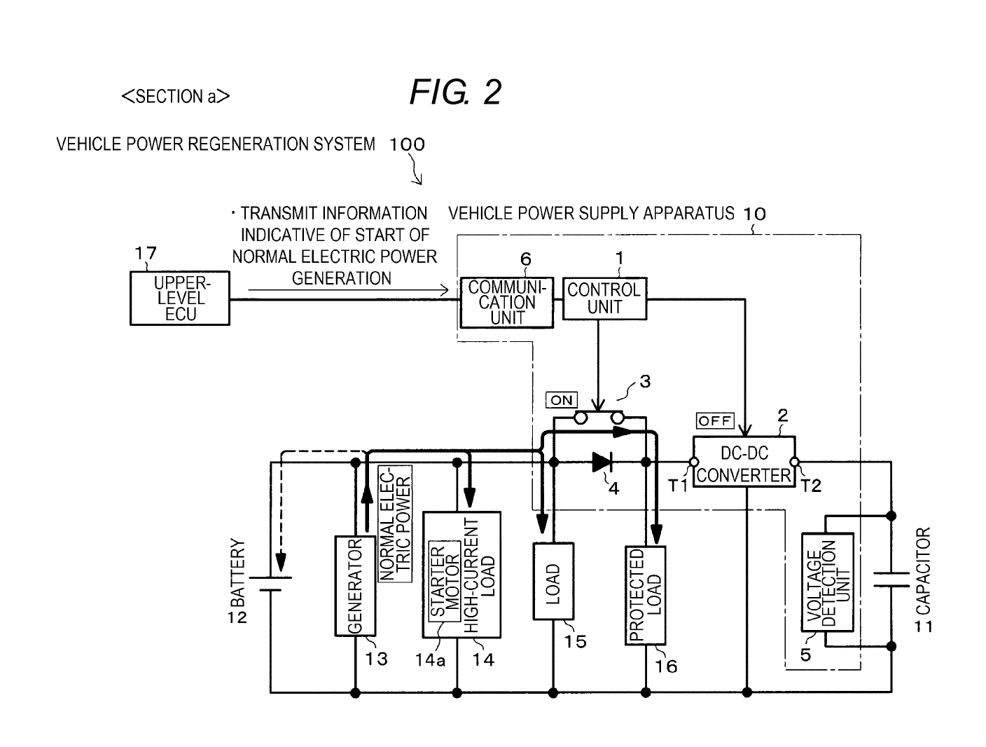

Subsequently, the operation of the vehicle power regeneration system 100 and the vehicle power supply apparatus 10 will be described with reference to FIGS. 2 to 7.

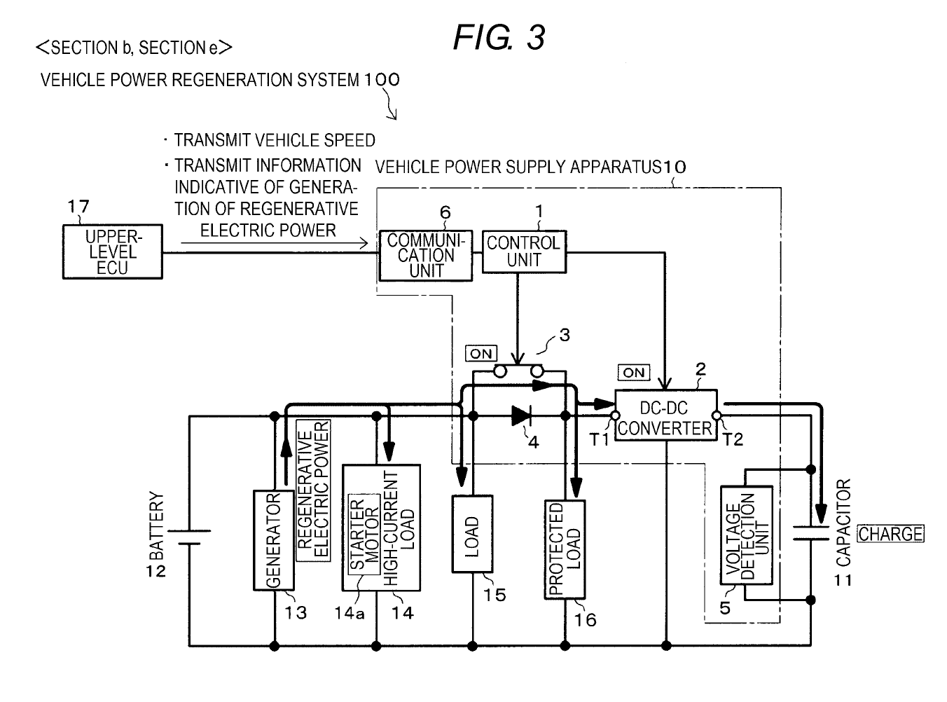

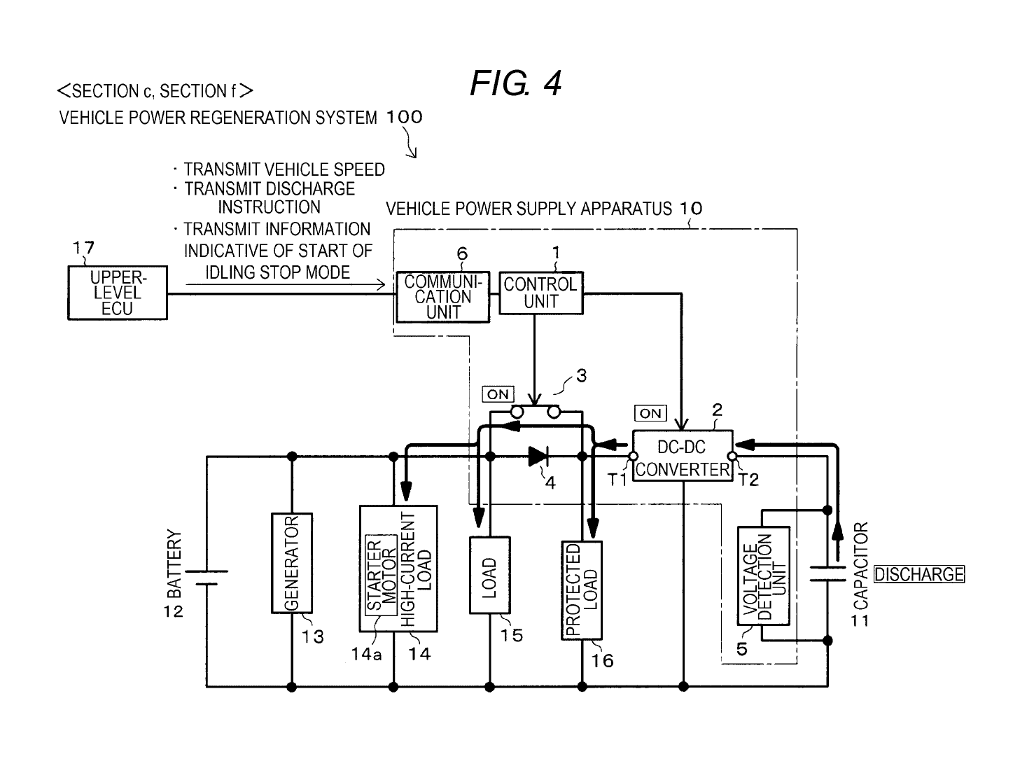

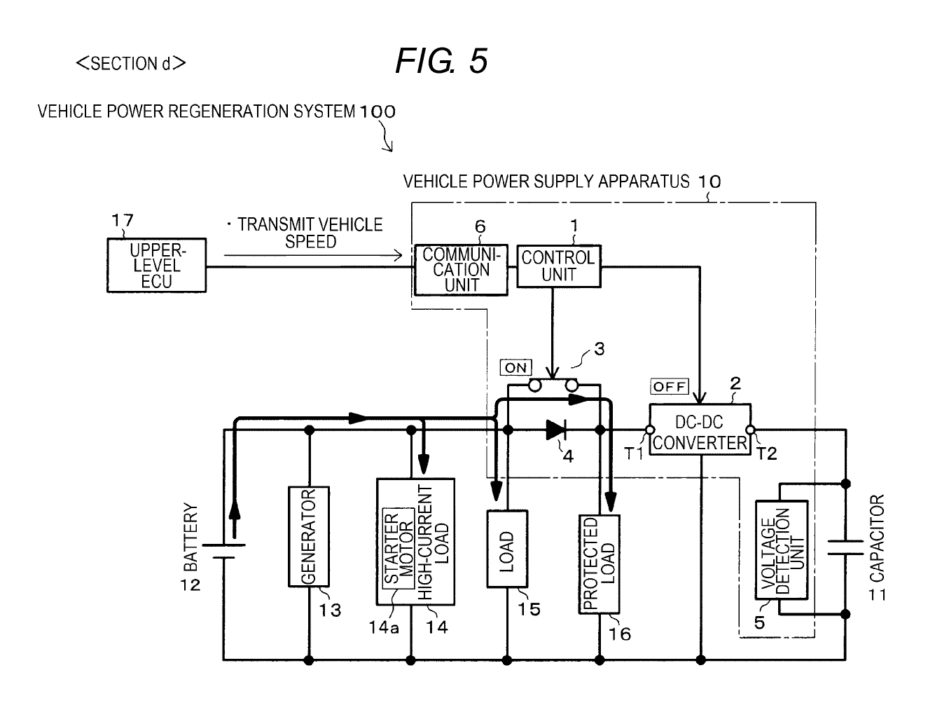

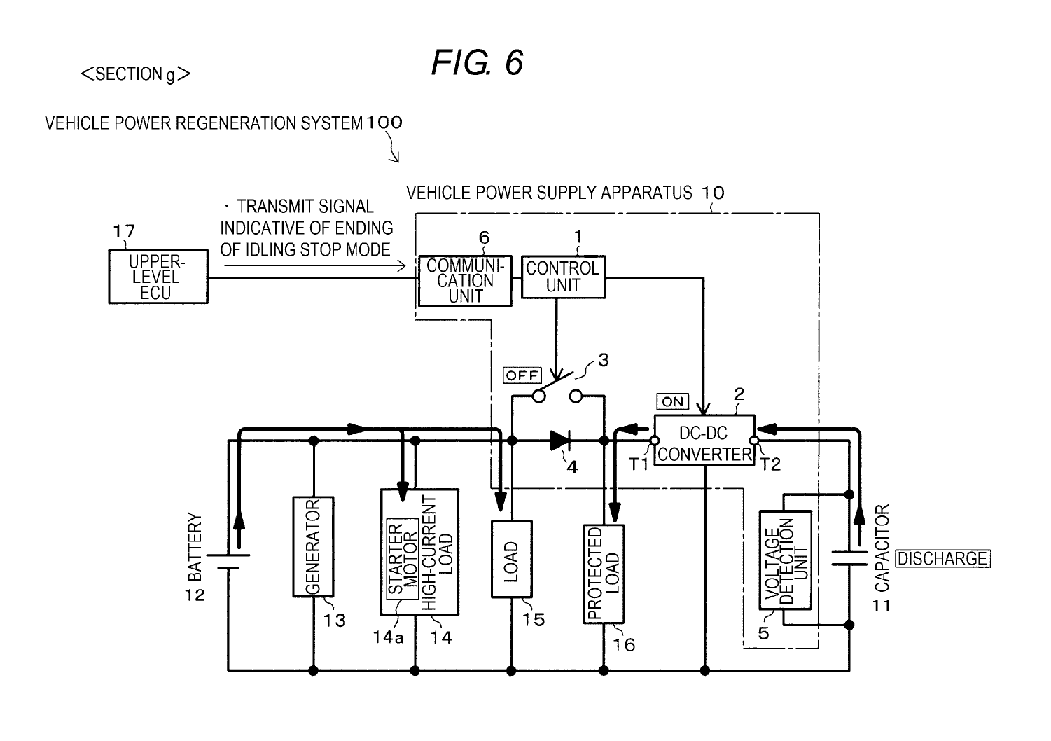

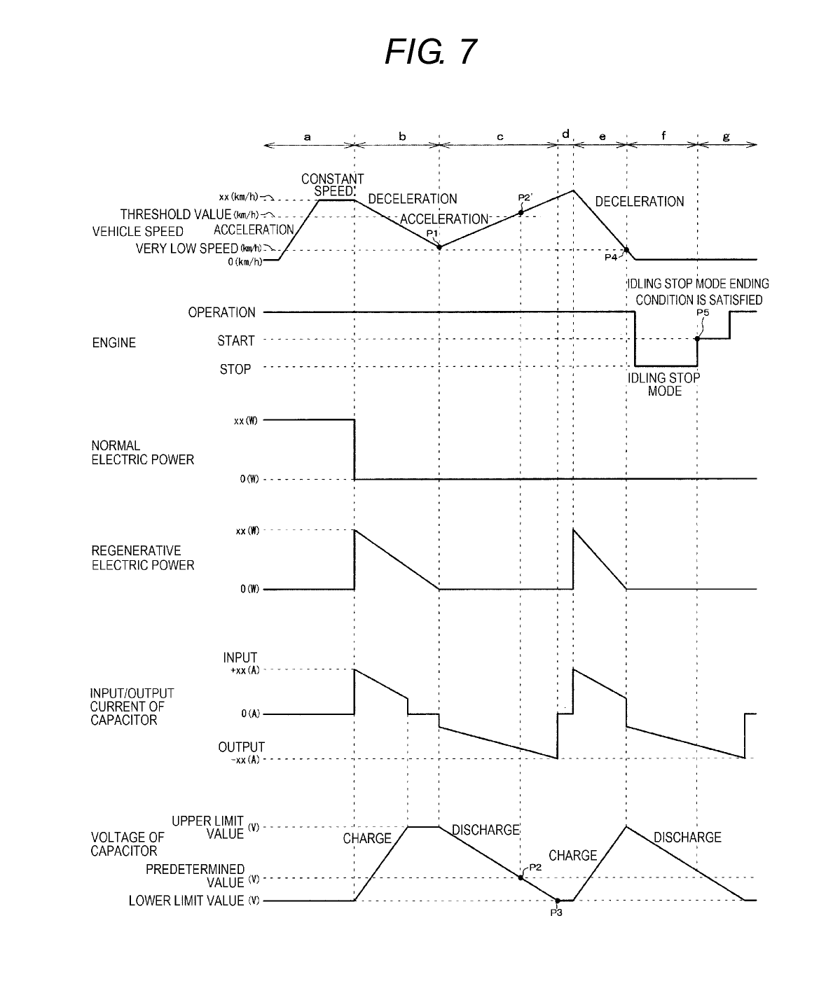

FIG. 2 illustrates a status of section a illustrated in FIG. 7, FIG. 3 illustrates a status of sections b and e illustrated in FIG. 7, FIG. 4 illustrates a status of sections c and f illustrated in FIG. 7, FIG. 5 illustrates a status of section d illustrated in FIG. 7, and FIG. 6 illustrates a status of section g illustrated in FIG. 7.

When a driving force of the engine drives the generator 13 during the acceleration, the constant-speed travelling, or the stopping of the vehicle (section a in FIG. 7), and normal power generation is performed, which consumes fuel, as illustrated by the solid arrow in FIG. 2, electric power generated by the generator 13 is supplied to the loads 14 and 15. When the control unit 1 of the vehicle power supply apparatus 10 receives information (may be vehicle speed information) indicative of the normal power generation of the generator 13 from the upper-level ECU 17 via the communication unit 6, the control unit 1 turns on the switch 3. Accordingly, electric power generated by the generator 13 is also supplied to the protected load 16 via the switch 3. Since the DC-DC converter 2 is in a non-operative state, electric power generated by the generator 13 is not supplied to the capacitor 11.

When the voltage of the battery 12 decreases during the normal power generation, as illustrated by the dotted arrow in FIG. 2, electric power generated by the generator 13 is supplied to the battery 12, and the battery 12 is charged with the electric power from the generator 13. In contrast, when the voltage of the battery 12 does not decrease, the electric power of the battery 12 is also supplied to the loads 14 to 16 (not illustrated). The high-current load 14 is appropriately driven with the electric power from the battery 12 or the generator 13.

When a driver reduces the speed of the vehicle by releasing an accelerator pedal or depressing a brake pedal while the vehicle is travelling, the generator 13 generates regenerative electric power (section b in FIG. 7). As illustrated in FIG. 3, the regenerative electric power is supplied from the generator 13 to the loads 14 and 15. When the voltage of the battery 12 decreases at that time, the regenerative electric power is supplied to the battery 12 from the generator 13, and the battery 12 is charged with the regenerative electric power (not illustrated).

When the control unit 1 receives information (information that may indicate that the speed of the vehicle is reduced) indicative of the generation of regenerative electric power by the generator 13 from the upper-level ECU 17 via the communication unit 6, the control unit 1 turns on the switch 3, and drives the DC-DC converter 2. Accordingly, as illustrated by the arrow in FIG. 3, the regenerative electric power is supplied from the generator 13 to the protected load 16 via the switch 3, and is input to the first input/output terminal T1 of the DC-DC converter 2. The control unit 1 controls the driving of the DC-DC converter 2 so that the voltage of the regenerative electric power is converted (stepped up or down) to a voltage corresponding to the capacitor 11, and current flows to the capacitor 11. Accordingly, the capacitor 11 is charged with the regenerative electric power, and as illustrated in section b in FIG. 7, the voltage of the capacitor 11 increases.

When the capacitor 11 is in a fully charged state, the control unit 1 stops the driving of the DC-DC converter 2 because the voltage of the capacitor 11 reaches an upper limit value. Accordingly, current does not flow from the DC-DC converter 2 to the capacitor 11.

When the vehicle is accelerated before the vehicle speed decreases to a very low speed (after point P1 in FIG. 7), the normal electric power generation that consumes fuel is not performed by the generator 13 so as to improve fuel consumption, and the upper-level ECU 17 transmits a discharge instruction to the vehicle power supply apparatus 10 (refer to FIG. 4).

When the control unit 1 receives the discharge instruction from the upper-level ECU 17 via the communication unit 6 while the vehicle is travelling and the generator 13 is not in an electric power generation mode, the control unit 1 confirms the voltage of the capacitor 11 detected by the voltage detection unit 5. When the voltage of the capacitor 11 is greater than a predetermined value, the control unit 1 turns on the switch 3, and controls the driving of the DC-DC converter 2 so that the capacitor 11 discharges electricity. Accordingly, as illustrated by the arrow in FIG. 4, electric power is supplied from the capacitor 11 to the protected load 16, and is supplied to the loads 14 and 15 via the switch 3. For this reason, the voltage of the capacitor 11 decreases (section c in FIG. 7).

The predetermined value compared to the voltage of the capacitor 11 is set to be higher than or equal to the value of the voltage of the capacitor 11, the voltage indicating a voltage at which the capacitor 11 can supply electric power required to drive the protected load 16 when the idling stop mode ends thereafter, and the engine is re-started.

When the voltage of the capacitor 11 being discharged decreases to the predetermined value (point P2 in FIG. 7), the control unit 1 confirms a current vehicle speed transmitted from the upper-level ECU 17 via the communication unit 6. When the current vehicle speed is greater than or equal to a threshold value (after point P2′ in FIG. 7), the control unit 1 continuously maintains the ON state of the switch 3, and controls the driving of the DC-DC converter 2 so that the capacitor 11 continuously discharges electricity. Accordingly, as illustrated in FIG. 4, electric power is continuously supplied from the capacitor 11 to the loads 14 to 16.

The threshold value compared to the vehicle speed is set to be higher than or equal to the value of a vehicle speed at which the capacitor 11 can be charged with regenerative electric power required to drive the protected load 16 when the engine is re-started, the regenerative electric power being generated by the generator 13 when the speed of the vehicle is reduced thereafter.

In contrast, if the vehicle speed is less than the threshold value when the voltage of the capacitor 11 decreases to the predetermined value (not illustrated), the control unit 1 maintains the switch 3 in the ON state, and stops the driving of the DC-DC converter 2 so that the discharging of the capacitor 11 is stopped (similar to the state illustrated in FIG. 5). Accordingly, electric power is supplied to the loads 14 to 16 not from the capacitor 11 but from the battery 12. The capacitor 11 holds electric power in preparation for the re-starting of the engine thereafter.

When the electric power of the capacitor 11 is used up, and the voltage of the capacitor 11 decreases to a lower limit value (point P3 in section d illustrated in FIG. 7) due to the discharge illustrated in section c in FIG. 7, as illustrated in FIG. 5, the control unit 1 continuously maintains the ON state of the switch 3, and stops the driving of the DC-DC converter 2 so that the discharging of the capacitor 11 is stopped. Accordingly, electric power is supplied to the loads 14 to 16 not from the capacitor 11 but from the battery 12.

Thereafter, as illustrated in section e in FIG. 7, when the speed of the vehicle is reduced, and the generator 13 generates regenerative electric power, as illustrated in FIG. 3, the control unit 1 turns on the switch 3 so that the regenerative electric power is supplied to the protected load 16 and is input to the DC-DC converter 2. The control unit 1 controls the driving of the DC-DC converter 2 so that the capacitor 11 is charged with the regenerative electric power.

When the speed of the vehicle is reduced, and the vehicle speed decreases to a very low speed (point P4 in FIG. 7), the generator 13 does not generate regenerative electric power (section f in FIG. 7). When the control unit 1 receives information from the upper-level ECU 17 via the communication unit 6, the information indicating that the vehicle speed is a very low speed, as illustrated in FIG. 4, the control unit 1 turns on the switch 3, and controls the driving of the DC-DC converter 2 so that the capacitor 11 discharges electricity. Accordingly, the electric power of the capacitor 11 is supplied to the loads 14 to 16.

When a predetermined idling stop entry condition is satisfied, for example, when the vehicle speed becomes zero (stopped state), an idling stop mode is started. When the control unit 1 receives information indicative of the starting of the idling stop mode from the upper-level ECU 17 via the communication unit 6, the control unit 1 maintains the switch 3 in the ON state, and causes the capacitor 11 to continuously discharge electricity using the DC-DC converter 2. Accordingly, as illustrated in FIG. 4, the electric power of the capacitor 11 is continuously supplied to the loads 14 to 16.

When a predetermined idling stop mode ending condition is satisfied during the idling stop of the vehicle, the idling stop mode ends (point P5 in FIG. 7). The idling stop mode ending condition is satisfied when the brake pedal is released, the accelerator pedal is depressed, the voltage of the battery 12 decreases, the voltage of the capacitor 11 decreases (less than or equal to the predetermined value), or the like.

As illustrated in FIG. 6, when the control unit 1 receives a signal indicative of the ending of the idling stop mode from the upper-level ECU 17 via the communication unit 6 in preparation for the re-starting of the engine, the control unit 1 turns off the switch 3 and controls the driving of the DC-DC converter 2 so that the capacitor 11 discharges electricity. Accordingly, as illustrated by the arrow in FIG. 6, the electric power of the capacitor 11 is supplied to the protected load 16 (section g in FIG. 7). The electric power of the battery 12 is supplied to the loads 14 and 15.

The starter motor 14a is started up using electric power from the battery 12. During the start-up of the starter motor 14a, the switch 3 is turned off, the capacitor 11 and the protected load 16 are electrically disconnected from the battery 12 and the starter motor 14a. For this reason, even though a high current flows from the battery 12 to the starter motor 14a, electric power is stably supplied from the capacitor 11 to the protected load 16 without a decrease in the voltage supplied to the protected load 16 from the capacitor 11. When the engine is re-started due to the start-up of the starter motor 14a, and then the engine operates, fuel is consumed. Thereafter, electric power supply modes illustrated in FIGS. 2 to 6 are repeated depending on a status of the vehicle, the charge level of the battery 12 or the capacitor 11, or the like.

In the embodiment, even if the voltage of the capacitor 11 being discharged decreases to the predetermined value while the vehicle is travelling and the generator 13 is not in an electric power generation mode, when the vehicle speed is greater than or equal to the threshold value, the capacitor 11 continuously discharges electricity, and the electric power of the capacitor 11 is supplied to the loads 14 to 16. For this reason, it is possible to improve the fuel consumption of the vehicle by using the electric power of the capacitor 11 charged with the regenerative electric power until the electric power is used up. Since the vehicle speed is greater than or equal to the threshold value, the capacitor 11 can be reliably charged with regenerative electric power generated by the generator when the speed of the vehicle is reduced thereafter. For this reason, when the idling stop mode ends thereafter, and the engine is re-started, the capacitor 11 discharges electricity, and electric power can be supplied from the capacitor 11 to the protected load 16. At this time, electric power can be supplied from the battery 12 to the other loads 14 and 15.

In the embodiment, when the voltage of the capacitor 11 being discharged decreases to the predetermined value while the vehicle is travelling and the generator 13 is not in an electric power generation mode and the vehicle speed is less than the threshold value, the switch 3 is turned on, and the driving of the DC-DC converter 2 is stopped so that the capacitor 11 does not discharge electricity. For this reason, if the capacitor 11 cannot be sufficiently charged with regenerative electric power when the vehicle speed slows down and then the speed of the vehicle is reduced, the capacitor 11 can hold electricity in preparation for the re-starting of the engine again thereafter.

In the embodiment, the predetermined value compared to the voltage of the capacitor 11 is set to be higher than or equal to the value of the voltage of the capacitor 11, the voltage indicating a voltage at which the capacitor 11 can supply electric power required to drive the protected load 16 when the engine is re-started. For this reason, even if the starter motor 14a is started up when the idling stop mode ends and the engine is re-started, it is possible to stably drive the protected load 16 by more reliably supplying electric power from the capacitor 11 to the protected load 16.

In the embodiment, the threshold value compared to the vehicle speed is set to be higher than or equal to the value of a vehicle speed at which the capacitor 11 can be charged with regenerative electric power required to drive the protected load 16 when the engine is re-started, the regenerative electric power being generated by the generator 13 when the speed of the vehicle is reduced thereafter. For this reason, when the vehicle speed is greater than or equal to the threshold value, even if the electric power of the capacitor 11 being discharged is used up, the capacitor 11 can be sufficiently charged with regenerative electric power generated by the generator 13 thereafter. In addition, even if the starter motor 14a is started up when the idling stop mode ends thereafter and the engine is re-started, the capacitor 11 can stably supply electric power to the protected load 16.

In the embodiment, when the generator 13 generates regenerative electric power, the switch 3 is turned on so that the regenerative electric power is supplied to the protected load 16, and the driving of the DC-DC converter 2 is controlled so that the capacitor 11 is charged with the regenerative electric power. For this reason, it is possible to effectively use regenerative electric power that is generated without the consumption of fuel.

In the embodiment, since a FET is used as the switch 3, to which the diode 4 is connected in parallel, the switch 3 can be switched highly reliably unlike other switches having mechanical contacts, and can reliably switch the electric power supply modes. Since the diode 4 is connected in such a manner that current flows from the battery 12 to the protected load 16, even though the battery is 12 connected in reverse during maintenance, current does not flow from the battery 12 to the DC-DC converter 2, the capacitor 11, or the protected load 16, and thereby the DC-DC converter 2, the capacitor 11, or the protected load 16 can be protected.

The invention can adopt various embodiments other than the aforementioned embodiment. For example, in the embodiment, the switch 3 configured as a FET is used as a switching element; however, the invention is not limited to this configuration. Switching elements other than a FET, for example, a relay and a transistor may be used. A rectifier such as the diode 4 may be connected in parallel to the switching element, or may be omitted.

In the embodiment, the idling stop mode entry condition is that the vehicle speed becomes zero; however, the invention is not limited to this configuration. In addition to the aforementioned condition, the idling stop mode entry condition may be defined as when the vehicle speed decreases to a very low speed, when a charge level of the capacitor 11 and the battery 12 is a predetermined charge level or higher, or the like.

In addition, in the embodiment, the invention is applied to the power regeneration system 100 and the power supply apparatus 10 of the vehicle that has the idling stop function and the deceleration regenerative function; however, the present invention is not limited to being applied to the vehicle. In addition to the aforementioned configuration, for example, the present invention can be applied to a power regeneration system and a power supply apparatus of a vehicle that has the deceleration regenerative function but does not have the idling stop function.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle power supply apparatus comprising:
a switching element comprising: one end connectable to a direct-current power supply to which a first load and a generator are connected in parallel; and the other end connectable to a second load which is required to be protected such that a voltage supplied to the second load does not decrease;
a bi-directional DC-DC converter comprising: a first input/output terminal connected to the other end of the switching element and the second load; and a second input/output terminal connected to an electricity storage unit which stores regenerative electric power generated by the generator;
a control unit which controls an operation of the switching element and the DC-DC converter;
a voltage detection unit which detects a voltage of the electricity storage unit; and
a communication unit which receives a status of a vehicle and a vehicle speed from an upper-level apparatus,
wherein when the vehicle is travelling, and the generator does not generate electricity,
if the voltage of the electricity storage unit is greater than a predetermined value, the control unit turns on the switching element, and controls driving of the DC-DC converter such that the electricity storage unit discharges electricity to supply electric power of the electricity storage unit to the first load and the second load, and
even if the voltage of the electricity storage unit decreases to the predetermined value, as long as the vehicle speed is greater than or equal to a threshold value, the control unit turns on the switching element, and controls the driving of the DC-DC converter such that the electricity storage unit discharges electricity to supply the electric power of the electricity storage unit to the first load and the second load.

2. The vehicle power supply apparatus according to claim 1,
wherein when the vehicle is travelling, and the generator does not generate electricity, if the voltage of the electricity storage unit decreases to the predetermined value, and the vehicle speed is less than the threshold value, the control unit turns on the switching element, and stops the driving of the DC-DC converter, such that the electricity storage unit does not discharge electricity.

3. The vehicle power supply apparatus according to claim 1,
wherein when an engine of the vehicle is re-started, the control unit turns off the switching element, and controls the driving of the DC-DC converter such that the electricity storage unit discharges electricity to supply the electric power of the electricity storage unit to the second load.

4. The vehicle power supply apparatus according to claim 1,
wherein the predetermined value is set to be higher than or equal to a value of the voltage of the electricity storage unit at which the electricity storage unit can supply electric power required to drive the second load when the engine of the vehicle is re-started.

5. The vehicle power supply apparatus according to claim 1,
wherein when the generator generates regenerative electric power, the control unit turns on the switching element to supply the regenerative electric power to the second load, and controls the driving of the DC-DC converter to charge the electricity storage unit with the regenerative electric power.

6. The vehicle power supply apparatus according to claim 1,
wherein the threshold value is set to be higher than or equal to a value of a vehicle speed at which the electricity storage unit can be charged with electric power required to drive the second load when the engine is re-started by the regenerative electric power generated by the generator by reduction of a speed of the vehicle thereafter.

7. The vehicle power supply apparatus according to claim 1,
wherein the switching element comprises a field effect transistor to which a rectifier is connected in parallel, and
wherein the rectifier allows current to flow from the direct-current power supply to the second load.

8. The vehicle power supply apparatus according to claim 1,
wherein the first load comprises a starter motor which is started up to start the engine, and through which a high current flows during start-up of the starter motor.

9. A vehicle power regeneration system comprising:
a direct-current power supply;
a first load and a generator which are connected in parallel to the direct-current power supply;
a second load which is required to be protected such that a voltage supplied to the second load does not decrease;
an electricity storage unit which stores regenerative electric power generated by the generator; and
a vehicle power supply apparatus which supplies electric power from the direct-current power supply and the electricity storage unit to the first load and the second load,
wherein the vehicle power supply apparatus comprises:
a switching element comprising: one end connected to a direct-current power supply; and the other end connected to a second load;
a bi-directional DC-DC converter comprising: a first input/output terminal connected to the other end of the switching element and the second load; and a second input/output terminal connected to an electricity storage unit;
a control unit which controls an operation of the switching element and the DC-DC converter;
a voltage detection unit which detects a voltage of the electricity storage unit; and
a communication unit which receives a status of a vehicle and a vehicle speed from an upper-level apparatus,
wherein when the vehicle is travelling, and the generator does not generate electricity,
if the voltage of the electricity storage unit is greater than a predetermined value, the control unit turns on the switching element, and controls driving of the DC-DC converter such that the electricity storage unit discharges electricity to supply electric power of the electricity storage unit to the first load and the second load, and
even if the voltage of the electricity storage unit decreases to the predetermined value, as long as the vehicle speed is greater than or equal to a threshold value, the control unit turns on the switching element, and controls the driving of the DC-DC converter such that the electricity storage unit discharges electricity to supply the electric power of the electricity storage unit to the first load and the second load.
